(19) United States
(12) Patent Application Publication
(10) Pub. No.: US 2021/0095597 A1
(43) Pub. Date: Apr. 1, 2021

(54) HEAT EXCHANGER OF A GAS TURBINE ENGINE OF AN AIRCRAFT

(71) Applicant: Rolls-Royce Deutschland Ltd & Co KG, Blankenfelde-Mahlow (DE)

(72) Inventors: Stephan UHKOETTER, Berlin (DE); Christian HELCIG, Wiedemar (DE)

(21) Appl. No.: 17/028,096

(22) Filed: Sep. 22, 2020

(30) Foreign Application Priority Data
Sep. 27, 2019 (DE) 10 2019 126 123.6

(51) Int. Cl. F02C 7/14; F02K 3/06; F28D 1/02; F28F 1/02; F28F 3/02; F28F 3/12

(52) U.S. Cl. CPC F02C 7/14; F02K 3/06; F28D 1/024; F28D 2021/0021; F28F 1/022; F28F 3/02; F28F 3/12; F28D 1/0246

(57) ABSTRACT

A heat exchanger of a gas turbine engine includes a casing having a stepped incident-flow profile. An air volume flow is, in the region of the incident-flow profile, diverted such that a recirculation zone with a separation bubble forms in the flow. Downstream of the incident-flow profile, is a further stepped incident-flow profile. The flow is diverted such that, downstream of the further incident-flow profile, a further recirculation zone forms in which a separation bubble is present. In the region of the incident-flow profile and/or the further incident-flow profile, is an inlet of a flow duct which runs in the casing in the direction of a mouth. An air volume flow conducted through the flow duct emerges from the mouth at such an angle relative to the flow direction of the air volume flow that, downstream of the mouth, a recirculation zone with a separation bubble forms.

This application claims priority to German Patent Application DE102019126123.6 filed Sep. 27, 2019, the entirety of which is incorporated by reference herein.

The present disclosure relates to a heat exchanger of a gas turbine engine of an aircraft, which heat exchanger has a casing and serves for controlling the temperature of a fluid, which can be conducted through the casing, by means of an air volume flow which is incident on the casing in an axial direction.

The waste heat generated by known gas turbine engines or aircraft engines during operation is released to the surroundings by means of known measures. A major part of the waste heat to be dissipated is released to the fuel that is to be burned. Since the heat energy that is transmissible to the fuel in each case is limited, gas turbine engines are designed with so-called oil-air heat exchangers. Oil-air heat exchangers are commonly arranged in the bypass flow duct of a gas turbine engine, at the radially inner side of the bypass flow duct or at the radially outer side of the bypass flow duct. The temperature of the oil conducted through the interior of the oil-air heat exchanger is controlled by means of the air volume flow which is conducted through the bypass flow duct and which flows over the heat exchanger at its outer side which faces toward the flow cross section, through which flow passes, of the bypass flow duct. To increase the surface area of the oil-air heat exchanger, oil-air heat exchangers are generally designed with cooling fins or lamellae which project into the air flow and which are oriented in the flow direction of the air volume flow in the bypass flow duct.

The efficiencies of such oil-air heat exchangers are however relatively low, because the heat transfer between the surface of the oil-air heat exchanger and the air volume flow impinging on said surface is inhibited after a certain traveling distance of the air volume flow along the surface of the oil-air heat exchanger. This results from the fact that the thickness of the boundary layer of the air volume flow increases along the surface of the heat exchanger, and thus the heat transfer coefficient decreases. The reduced heat transfer coefficient has the result that the surface of the oil-air heat exchanger must be dimensioned to be very large. For this purpose, the oil-air heat exchanger and/or the cooling fins thereof is or are enlarged. This is however in turn possible only to a very restricted extent, because the contact area between the region wetted by oil and the oil-air heat exchanger is under some circumstances limited.

The present disclosure is based on the object of providing a heat exchanger, which is favorable in terms of structural space and which is distinguished by high efficiency, of a gas turbine engine of an aircraft.

This object is achieved by a heat exchanger having the features of Patent claim 1.

According to a first aspect, a heat exchanger of a gas turbine engine of an aircraft having a casing is provided in order to be able to control the temperature of a fluid, which can be conducted through the casing, by means of an air volume flow which is incident on the casing in an axial direction. The casing has a step-like incident-flow profile in a region facing toward the flow of the air volume flow. The air volume flow is, in the region of the incident-flow profile, diverted in relation to an outer side of the casing such that the flow of the air volume flow grows above the outer side of the casing at least approximately perpendicularly with respect to the outer side, over which flow passes, of the casing, or, in relation to the main flow direction of the air volume flow upstream of the incident-flow profile, downstream of the incident-flow profile expands at least approximately in a radial direction above the outer side, in such a way that, downstream of the incident-flow profile and above the outer side of the casing, a recirculation zone with at least one separation bubble forms in the air volume flow.

Downstream of the incident-flow profile, there is provided a further step-like incident-flow profile which, in relation to the outer side of the casing and in relation to the inner region of the casing, rises outwardly, is impinged on by the air volume flow and diverts the air volume flow. Here, the air volume flow is diverted in the region of the further incident-flow profile such that, downstream of the further incident-flow profile and above the outer side of the casing, a further recirculation zone forms in which in each case at least one separation bubble is present.

In addition or as an alternative to the further incident-flow profile, in the region of the incident-flow profile and/or in the region of the further incident-flow profile, there may be provided an inlet of at least one flow duct which runs in the casing in the direction of a mouth. The air volume flow conducted through the flow duct or the air volume flows conducted through the flow ducts emerges from the mouth or emerge from the mouths in each case at such an angle relative to the flow direction of the air volume flow that, downstream of the mouth or downstream of the mouths, in each case one recirculation zone with at least one separation bubble forms above the outer side(s) of the casing.

The targeted generation of recirculation zones with separation bubbles in accordance with the present disclosure gives rise in each case to a transition from a laminar flow profile to a turbulent flow profile of the flow of the air volume flow. This increases the heat transfer coefficient at the outer side of the heat exchanger after only a relatively short traveling distance. Furthermore, the average quantity of heat transferred in relation to the surface area of the heat exchanger required for this is increased in relation to solutions known from the prior art.

The turbulent boundary layer which attaches to the surface of the heat exchanger again after the recirculation phase significantly improves the heat transfer between the air volume flow and the fluid conducted through the casing.

By means of the heat transfer coefficient increased in the manner described in more detail above, it is in turn possible to design the heat exchanger to be smaller without reducing the temperature control performance thereof. In this way, weight savings and material savings and an oil circuit which can under some circumstances be dimensioned to be smaller in the region of the heat exchanger are possible. Furthermore, it is also possible for the fluid which is conducted through the casing, such as oil or the like, to release a greater quantity of heat to the air volume flow flowing past if the heat exchanger has approximately similar dimensions to conventionally designed heat exchangers.

The recirculation zone or the separation bubble may have a defined length in the flow direction of the air volume flow, which length is dependent on a height of the effective area of the incident-flow profile. Here, the effective area of the incident-flow profile corresponds to an area of the incident-flow profile projected into a plane which is perpendicular to the flow direction of the air volume flow.

According to a further aspect of the present disclosure, the air volume flow is, in the region of the incident-flow profile or in the region of the incident-flow pro-files and/or in the region of the mouth or in the region of the mouths, diverted relative to the outer side of the casing in a growing or expanding manner such that, in the flow direction of the air volume flow, the recirculation zones are adjoined by in each case one reattachment region. In this way, an improvement of the heat transfer coefficient is achieved in a simple manner.

Here, the mouth may be arranged at least approximately in the region of the outer side of the casing or the mouths may be arranged in each case in the region of the outer sides of the casing in which the recirculation zone ends in each case or in which the recirculation zones end in each case.

Furthermore, it may be provided that the mouth or the mouths is arranged in each case at least approximately in the region of the outer side or are arranged in each case in the region of the outer sides of the casing in which the reattachment region is present or in which the reattachment regions are present.

In a further embodiment of the heat exchanger according to the present disclosure, the air volume flow is, in the region of the incident-flow profile or in the region of the incident-flow profiles and/or in the region of the mouth or in the region of the mouths, diverted relative to the outer side of the casing in a growing or expanding manner such that, in the flow direction of the air volume flow, the reattachment regions are adjoined by in each case one turbulent flow region. In other words, the growing boundary layer of the air flow in the region of the incident-flow profiles and/or in the region of the mouth or in the region of the mouths in relation to the outer side of the casing is utilized in that, in the flow direction of the air volume flow, the reattachment regions are adjoined by in each case one turbulent flow region of the air volume flow. In this way, again, an improvement of the heat transfer coefficient is achieved in a simple manner.

Furthermore, on the outer side of the casing, there may be provided cooling fins which extend outward in relation to the outer side of the casing and which run at least approximately in the flow direction of the air volume flow and which are spaced apart from one another in a direction which is perpendicular to the flow direction of the air volume flow or which corresponds to a transverse direction of the casing. In this way, again in a manner which is favorable in terms of structural space, the surface area of the heat exchanger is enlarged, and a level of performance of the heat exchanger is improved.

In advantageous refinements of the heat exchanger according to the present disclosure, the incident-flow profile or the incident-flow profiles and/or the outer sides of the casing are arranged, in the flow direction, upstream of or at least regionally between the cooling fins.

In order to be able to maximize an efficiency of the heat exchanger in particular in the region of the cooling fins, a height of the cooling fins proceeding from the outer side or proceeding from the outer sides of the casing may be designed to be constant, or to increase at least regionally in the flow direction, over the length of the cooling fins.

In a manner dependent on the respectively present usage situation, it is possible for the height of the ribs to be configured to rise in linear or parabolic fashion.

If a spacing between in each case two incident-flow profiles in the flow direction of the air volume flow lies in a range between one and ten times the height of the in each case front incident-flow profile in the flow direction of the air volume flow, it is possible, in the region of the heat exchanger, to attain a high heat transfer capacity with simultaneously small dimensions of the heat exchanger. Here, it may be provided that the spacing between in each case two incident-flow profiles lies in a range between four and five times the height of the front incident-flow profile.

The cooling fins may end, in the flow direction of the air volume flow, upstream of those regions of the outer sides of the casing in which the mouths of the flow ducts are arranged, and/or begin downstream of the regions. In this way, it is achieved in a simple manner that the recirculation zones with separation bubble, generated as a result of the passive injection, are not impaired by the presence of cooling fins.

In a structurally simple embodiment of the heat exchanger according to the present disclosure, the step-like incident-flow profiles extend at least approximately transversely with respect to the flow direction of the air volume flow.

In a further structurally simple embodiment of the heat exchanger according to the present disclosure, the step-like incident-flow profiles are formed at least regionally with a convex and/or planar face area directed counter to the flow direction of the air volume flow, which face areas enclose in each case an angle of between 0° and 90° with the outer sides of the casing. It is thus possible in a simple manner for relatively long or relatively short recirculation zones or separation bubbles to be generated in a manner dependent on the respectively present structural form of the heat exchanger. Here, the length of the recirculation zones or of the separation bubbles can be controlled or generated by means of the geometrical shape of separation edges between the face areas of the incident-flow profiles and the outer areas of the casing.

The casing of the heat exchanger, in the assembled operating state, may extend in a circumferential direction of the gas turbine engine and be of curved form in the circumferential direction and, in the circumferential direction, delimit a flow region of the air volume flow. This is advantageous for example in the case of an arrangement of the heat exchanger in the bypass flow duct.

Furthermore, the casing of the heat exchanger may be designed as a closed ring-shaped body or as a ring segment.

Irrespective of whether the heat exchanger delimits the flow region of the air volume flow in the circumferential direction entirely or only partially radially to the inside or radially to the outside, the casing of the heat exchanger may be of ring-shaped, elliptical or circular design. Furthermore, it is possible for multiple heat exchanger portions or heat exchangers to be provided which are arranged so as to be distributed over the circumference and which are spaced apart from one another in the circumferential direction of the flow region.

It is self-evident to a person skilled in the art that a feature or parameter described in relation to one of the above aspects can be applied to any other aspect, unless these are mutually exclusive. Furthermore, any feature or any parameter described here may be applied to any aspect and/or combined with any other feature or parameter described here, unless these are mutually exclusive.

Embodiments will now be described, by way of example, with reference to the figures.

### IN THE FIGURES

FIG. 1 shows a highly schematic longitudinal section through a gas turbine engine of an aircraft having a heat exchanger;

FIG. 2 shows a sectional view of a first embodiment of the heat exchanger of the gas turbine engine as per FIG. 1;

FIG. 3 shows an illustration corresponding to FIG. 2 of a further embodiment of the heat exchanger;

FIG. 4 shows a plan view of a region IV of the heat exchanger as per FIG. 3;

FIG. 5 shows an illustration corresponding to FIG. 2 of a further embodiment of the heat exchanger;

FIG. 6 shows a plan view of a region VI of the heat exchanger as per FIG. 5;

FIG. 7 shows a longitudinal sectional view of a further embodiment of the oil-air heat exchanger;

FIG. 8 shows a three-dimensional partial illustration of a further embodiment of the oil-air heat exchanger;

FIG. 9 shows an illustration corresponding to FIG. 8 of a further embodiment of the heat exchanger;

FIG. 10 shows an illustration corresponding to FIG. 8 of a further embodiment of the heat exchanger;

FIG. 11 shows an illustration corresponding to FIG. 8 of a further exemplary embodiment of the heat exchanger; and

FIG. 12 shows an illustration corresponding to FIG. 8 of a further embodiment of the heat exchanger.

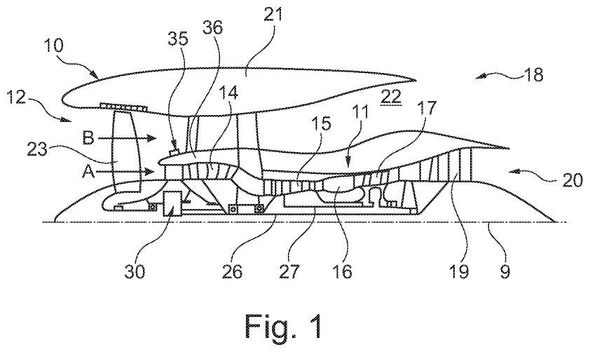

FIG. 1 shows a gas turbine engine 10 with a main axis of rotation 9. The gas turbine engine 10 comprises an air inlet 12 and a fan 23 that generates two air flows: a core air flow A and a bypass air flow B. The gas turbine engine 10 furthermore comprises an engine core 11 that receives the core air flow A. In the axial flow direction, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a shaft 26 and an epicyclic gear box 30.

During operation of the gas turbine engine 10, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before they are expelled through the nozzle 20 to provide a certain propulsive thrust. The high-pressure turbine 17 drives the high-pressure compressor 15 by means of a suitable connecting shaft 27. The fan 23 generally provides the major part of the propulsive thrust. The epicyclic gear box is a reduction gear box.

Attention is drawn to the fact that the expressions “low-pressure turbine” and “low-pressure compressor”, as used herein, can be taken to mean the lowest-pressure turbine stage and lowest-pressure compressor stage (i.e. not including the fan 23), respectively, and/or the turbine and compressor stages that are connected together by the connecting shaft with the lowest rotational speed in the gas turbine engine (i.e. not including the gear box output shaft that drives the fan 23). Alternatively, there is furthermore also the possibility that the low-pressure turbine and the low-pressure compressor to which reference is made here are the medium-pressure turbine and the medium-pressure compressor. Where such alternative nomenclature is used, the fan can be referred to as a first, or lowest-pressure, compression stage.

Other gas turbine engines in which the present disclosure can be used may have alternative configurations. For example, such engines may have an alternative number of compressors and/or turbines and/or an alternative number of connecting shafts. As a further example, the gas turbine engine shown in FIG. 1 has a split flow nozzle 20, 22. This means that the flow through the bypass duct 22 has a dedicated nozzle which is separate from the engine core nozzle 20 and radially on the outside thereof. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable area. Although the example described relates to a turbofan engine, the disclosure can be applied, for example, to any type of gas turbine engine, such as, for example, an open rotor engine (in which the fan stage is not surrounded by an engine nacelle) or a turboprop engine. In some arrangements, the gas turbine engine 10 may not comprise a gear box 30.

The geometry of the gas turbine engine 10, and components thereof, is or are defined using a conventional axis system which comprises an axial direction (which is aligned with the axis of rotation 9), a radial direction (in the direction from bottom to top in FIG. 1), and a circumferential direction (perpendicular to the view in FIG. 1). The axial, radial and circumferential directions run so as to be mutually perpendicular.

Additionally, the gas turbine engine 10 as per FIG. 1 comprises a heat exchanger 35, which is arranged in the present case on the inner diameter of the bypass duct 22 on an intermediate casing 36 and surrounds the intermediate casing 36 in a circumferential direction of the gas turbine engine 10.

As an alternative to this, the heat exchanger 35 may also be arranged in the region of the outer diameter of the bypass duct 22, which is the same as the diameter of the inner side of the engine nacelle 21. Furthermore, it is also possible for at least one heat exchanger 35 to be provided both on the inner diameter and on the outer diameter of the bypass duct 22.

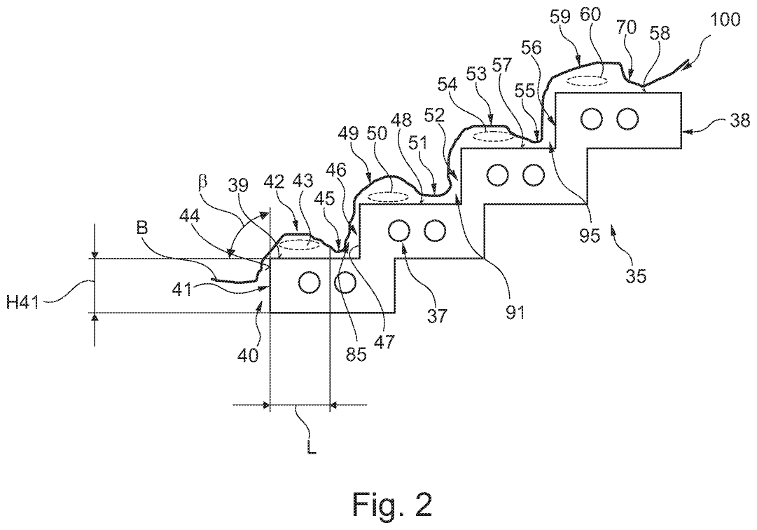

FIG. 2 to FIG. 12 show various embodiments of the heat exchanger 35, which in the present case is designed as an oil-air heat exchanger. Here, oil of an oil circuit of the gas turbine engine 10 is conducted through an inner region 37 of a casing 38 of the heat exchanger 35. An outer side 39 of the heat exchanger 35 is impinged on by the bypass air flow B. The heat exchanger 35 may be designed as a concurrent-flow, counterflow or cross-flow heat exchanger, or else may have any desired combination of the latter structural forms. In the present case, the oil is, in relation to the main flow direction of the bypass air flow B through the bypass channel 22, oil conducted transversely or in a cross-flow configuration with respect to the bypass air flow B or the air volume flow through the casing 38.

The heat exchanger 35 constitutes a device of the gas turbine engine 10, in the region of which the fluid or oil that can be conducted through the casing 38 is temperature-controlled by means of the bypass air flow B impinging on the housing 38 or by means of the air volume flow conducted through the bypass duct 22.

The casing 38 has a first step-like incident-flow profile 41 in a region 40 facing toward the flow of the air volume flow B. Here, the air volume flow B is, in the region of the incident-flow profile 41, diverted outward in relation to the inner region 37 or the outer side 39 of the casing 38 such that a recirculation zone 42 with at least one separation bubble 43 forms downstream of the incident-flow profile 41 and above the outer side 39 of the casing 38 in the air volume flow B.

In the present case, the flow of the air volume flow B is, downstream of the incident-flow profile 41, diverted radially outward in relation to the main axis of rotation 9 and the outer side 39 of the casing 38.

If the heat exchanger 35 is arranged in the region of the outer diameter of the bypass channel 22, the air volume flow B is, downstream of the incident-flow profile 41 in relation to the main axis of rotation 9 and in relation to the then radially inwardly directed outer side 39 of the heat exchanger 35, diverted radially inward in relation to the main axis of rotation 9 and the outer side 39 of the casing 38.

The separation bubble 43 and the recirculation zone 42 have a defined length L. The defined length L of the recirculation zone 42 and of the separation bubble 43 is dependent on a height H41 of the effective area of the incident-flow profile 41. The effective area of the incident-flow profile 41 corresponds to an area 44 of the incident-flow profile 41 projected into a plane which is perpendicular to the flow direction of the air volume flow B. The recirculation zone 42 is adjoined by a reattachment region 45. In the reattachment region 45, the flow of the air volume flow B re-attaches to the outer surface 39 of the heat exchanger 35. Additionally, the reattachment region 45 is adjoined by a turbulent flow region 85, in which the flow of the air volume flow B, above the outer side 39 of the casing 38, expands again or grows over the further flow path.

Downstream of the incident-flow profile 41, there is provided a further step-like incident-flow profile 46. The further step-like incident-flow profile 46 rises, relative to the outer side 39 between the incident-flow profile 41 and the further incident-flow profile 46, outwardly in relation to the inner region 37 of the casing 38. The further incident-flow profile 46 or the area 47 thereof is impinged on by the air volume flow B and diverts the air volume flow B outward to the extent illustrated in FIG. 2. Here, the air volume flow B is diverted by the further incident-flow profile 46, which is designed substantially similarly to the incident-flow profile 41, such that, downstream of the further incident-flow profile 46, above a further outer side 48 of the casing 38, there is formed a further recirculation zone 49 with a defined length L in the flow direction, in which in turn there is situated a separation bubble 50.

The recirculation zone 49 and the separation bubble 50 are adjoined firstly in turn by a reattachment region 51 and, adjoining this, in turn, a turbulent flow region 91. The further turbulent flow region 91 extends as far as an additional incident-flow profile 52, which in turn substantially corresponds to the incident-flow profile 41. The additional incident-flow profile 52 is in turn impinged on by the air volume flow B and diverts this to the extent described in more detail above, such that, downstream of the incident-flow profile 52, in turn, there is formed a recirculation zone 53 with a separation bubble 54. Downstream of the recirculation zone 53, in turn, there is formed firstly a further reattachment region 55 and, adjoining this, a further turbulent flow region 95, which extends as far as a further incident-flow profile 56.

The heat exchanger 35 is thus formed with incident-flow profiles 41, 46, 52 and 56 which follow one another at least approximately in a stepped or staircase-like manner, in order to generate, downstream of each of the incident-flow profiles 41, 46, 52 and 56, recirculation zones 42, 49, 53, 59 and separation bubbles 43, 50, 54, 60 and, adjoining each of these, reattachment regions 45, 51, 55, 70 and, adjoining these, turbulent flow regions 85, 91, 95 and 100, which in each case improve a heat transfer coefficient.

Here, the heights of the incident-flow profiles 41, 46, 52 and 56 and also the axial spacings between the incident-flow profiles 41, 46, 52 and 56 are in the present case of equal magnitude. In a manner dependent on the respectively present usage situation, it is however also possible for the heights of the incident-flow profiles 41, 46, 52 and 56 and also the axial spacings between the incident-flow profiles 41, 46, 52 and 56 to differ from one another in each case, or to be only partially identical.

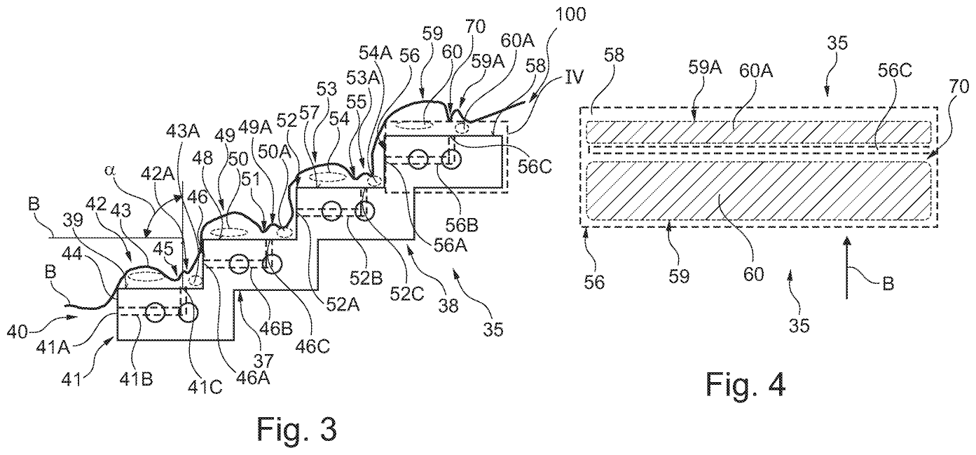

FIG. 3 shows an illustration corresponding to FIG. 2 of a further exemplary embodiment of the heat exchanger 35. The heat exchanger 35 as per FIG. 3 has substantially the same construction as the heat exchanger 35 as per FIG. 2. However, the heat exchanger 35 as per FIG. 3 is, in the region of the incident-flow profiles 41, 46, 52 and 56, formed in each case with an inlet 41A, 46A, 52A and 56A of flow channels 41B, 46B, 52B and 56B. The flow channels 41B to 56B run in the casing 38 of the heat exchanger 35 in each case in the direction of mouths 41C, 46C, 52C and 56C which are arranged at least approximately in regions of outer sides 39, 48, 57 and 58 of the heat exchanger 35 in which the recirculation zones 85, 91, 95 and 100 are respectively present.

Via the inlets 41A to 56A of the flow channels 41B to 56B, in each case one air volume flow is conducted in the direction of the mouths 41C to 56C. In the exemplary embodiment considered here, the air volume flows in the flow channels 41B to 56B are each diverted through 90° in relation to the main flow direction of the air volume flow B in the bypass duct 22 and introduced into the turbulent boundary layers or flow regions 45, 51, 55, 70 of the air volume flow B above the outer sides 39 to 58 at a defined angle α relative to the main flow direction of the air volume flow B which the air volume flow B has in particular upstream of the incident-flow profile 41. This so-called passive injection has the effect that respective further recirculation zones 46A, 49A, 53A and 59A with separation bubbles 43A, 50A, 54A and 60A form downstream of the mouths 41C to 56C. Thus, the heat transfer coefficient is further improved in each case in the region of the outer sides 39, 48, 57 and 58 of the heat exchanger 35.

Here, the defined angle α may have values between 80° and 140°.

In further embodiments of the heat exchanger, it is possible for the air volume flows in the flow channels 41B to 56B to be diverted by angular values greater than or less than 90° between the inlets 41A to 56A and the mouths 41C to 56C.

FIG. 4 shows a plan view of a region IV, indicated in more detail in FIG. 3, of the heat exchanger 35, which region comprises the incident-flow profile 56, the mouth 56C and the two recirculation zones 59 and 59A.

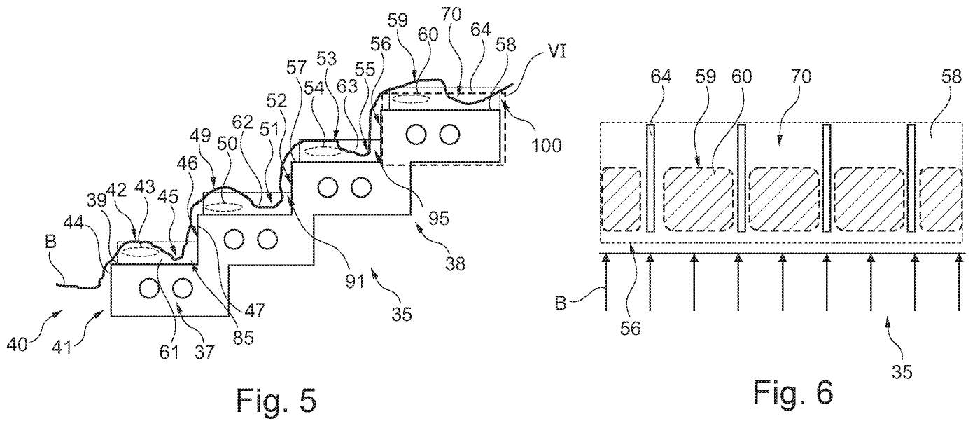

FIG. 5, shows, in turn, an illustration corresponding to FIG. 2 of a further exemplary embodiment of the heat exchanger 35, which in turn substantially corresponds to the heat exchanger 35 as per FIG. 2. The heat exchanger 35 as per FIG. 5 comprises respective cooling fins 61 to 64 in each case on the outer sides 39, 48, 57 and 58. The cooling fins 61 to 64 extend in each case outward in relation to the inner region 37 or the outer sides 39 to 58 of the casing 38 of the heat exchanger 35, and run at least approximately in the flow direction of the air volume flow B. Additionally, the cooling fins 61 to 64 are spaced apart from one another in the circumferential direction of the heat exchanger 35 in the manner illustrated in more detail in FIG. 6. Here, FIG. 6 shows the cooling fins 64 and a region VI, indicated in more detail in FIG. 5, in a view from above. It can be seen from the illustrations as per FIG. 5 and FIG. 6 that the recirculation zones 42, 49, 53, 59, the reattachment regions 45, 51, 55 and 70 and the turbulent flow regions 85, 91, 95 and 100 are divided in the circumferential direction of the heat exchanger 35, or in the flow direction of the oil in the casing 38, by the cooling fins 61 to 64.

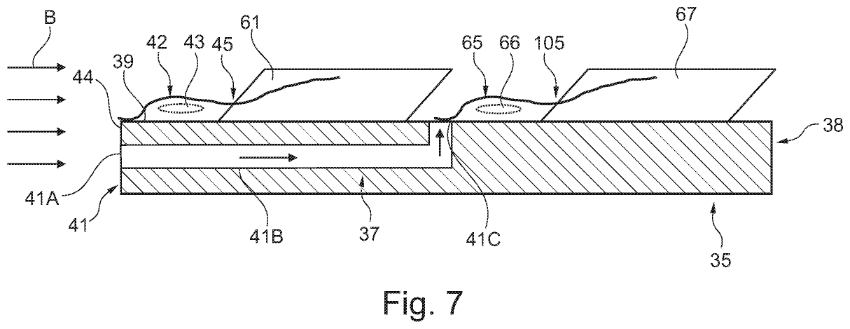

FIG. 7 shows a further exemplary embodiment of the heat exchanger 35 in a schematic longitudinal sectional view. Here, the heat exchanger 35 as per FIG. 7 is formed only with the incident-flow profile 41. The recirculation zone 42 and the separation bubble 43 form, in turn, downstream of the incident-flow profile 41. The recirculation zone 42 is adjoined, in turn, by the reattachment region 45. In the reattachment region 45, there are provided first cooling fins 61, which extend in the main flow direction of the air volume flow B as far as a short distance upstream of the mouth 41C of the flow channel 41B. The air volume flow B which emerges through the mouth 41C substantially perpendicularly outward from the casing 38 in relation to the outer side 39 of the casing 38 leads, in turn, to a breakup of the boundary layer of the air volume flow B downstream of the cooling fins 61, which in turn generates a further recirculation zone 65 and a further separation bubble 66. In a further reattachment region 105, there are provided further cooling fins 67, the height of which, like the height of the cooling fins 61, is substantially constant in the main flow direction of the air volume flow B.

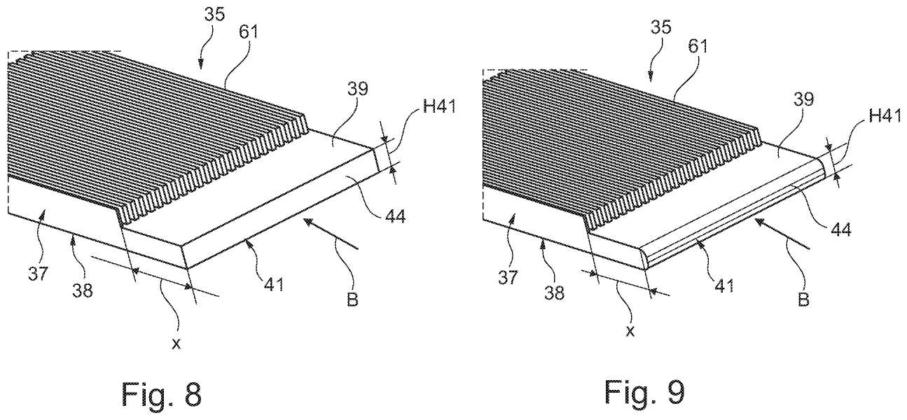

FIG. 8 shows a schematic three-dimensional partial view of a further exemplary embodiment of the heat exchanger 35. The heat exchanger 35 as per FIG. 8 is designed with an incident-flow profile 41, the area 44 of which encloses, with the outer side 39, an angle β which corresponds to approximately 90°. Thus, the heat exchanger 35 has an obtuse-angled edge at the transition between the area 44 and the outer side 39.

By contrast to this, the heat exchanger 35 as per FIG. 9 is formed with a rounded edge between the area 44 of the incident-flow profile 41 and the outer side 39, whereby the area 44 encloses an angle β equal to 0° with the outer side 39 in the transition region. The configuration of the heat exchanger 35 as per FIG. 8 has the effect that the recirculation zone 42 adjoining the incident-flow profile 41, and the separation bubble 43, have a greater length L than the recirculation zone 42 and the separation bubble 43 downstream of the incident-flow profile 41 of the heat exchanger 35 as per FIG. 9.

An axial spacing x in the main flow direction of the air volume flow B between the incident-flow profile 41 and the start of the cooling fins 61 is equal, in both embodiments of the heat exchanger 35 as per FIG. 8 and FIG. 9, to the product of the height H41 of the incident-flow profile 41 and a factor, which in the present case is equal to 4.5.

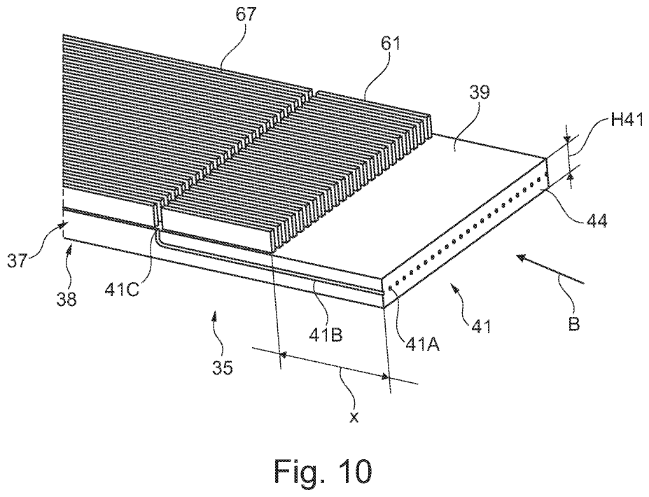

FIG. 10 is a three-dimensional partial view of the heat exchanger 35, the design of which substantially corresponds to the embodiment described in more detail with regard to FIG. 7.

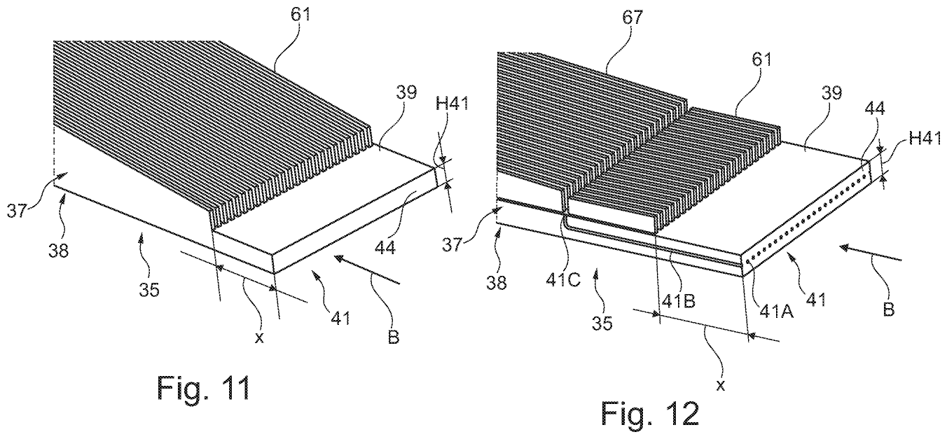

FIG. 11, in turn, shows an illustration, corresponding to FIG. 8, of a further exemplary embodiment of the heat exchanger 35, which differs from the exemplary embodiment of the heat exchanger 35 illustrated in FIG. 8 by the fact that a height of the cooling fins 61 increases linearly in the main flow direction of the air volume flow B.

Additionally shown in FIG. 12 is a further exemplary embodiment of the heat exchanger 35, which substantially corresponds to the exemplary embodiment of the heat exchanger 35 illustrated in FIG. 10. That region of the cooling fins 61 of the heat exchanger 35 which extends between the incident-flow profile 41 and the mouth 41C in FIG. 12 is formed with a height which is constant in the main flow direction of the air volume flow B. That region of the cooling fins 69 which adjoins the mouth 41C in a downstream direction rises in the present case linearly in the main flow direction of the air volume flow B. As an alternative to this, it is in turn possible for the height of the cooling fins 67 to rise parabolically in the main flow direction of the air volume flow B.

### LIST OF REFERENCE SIGNS

9 Main axis of rotation

10 Gas turbine engine

11 Engine core

12 Air inlet

14 Low-pressure compressor

15 High-pressure compressor

16 Combustion device

17 High-pressure turbine

18 Bypass thrust nozzle

19 Low-pressure turbine

20 Core thrust nozzle

21 Engine nacelle

22 Bypass duct

23 Fan

26 Shaft

27 Shaft

30 Epicyclic gear box

35 Heat exchanger

36 Intermediate casing

37 Inner region of the casing of the heat exchanger

38 Casing of the heat exchanger

39 Outer side of the casing

40 Region

41 Incident-flow profile

41A Inlet of the flow duct

41B Flow duct

41C Mouth

42 Recirculation zone

42A Further recirculation zone

43 Separation bubble

43A Further separation bubble

44 Area of the incident-flow profile 41

45 Reattachment region

46 Further incident-flow profile

46A Inlet

46B Flow duct

46C Mouth

47 Effective area of the further incident-flow profile

48 Outer side of the casing

49 Further recirculation zone

49A Further recirculation zone

50 Separation bubble

50A Further separation bubble

51 Further reattachment region

52 Additional incident-flow profile

52A Inlet

52B Flow duct

52C Mouth

53 Recirculation zone

53A Further recirculation zone

54 Separation bubble

54A Further separation bubble

55 Further reattachment region

56 Further incident-flow profile

56A Inlet

56B Flow duct

56C Mouth

57 Outer side

58 Outer side

59 Recirculation zone

59A Further recirculation zone

60 Separation bubble

60A Separation bubble

61 to 64 Cooling fins

65 Further recirculation zone

66 Further detachment bubble

67 Cooling fins

70 Reattachment region

85, 91, 95, 100 Turbulent flow region

105 Reattachment region

A Core flow

B Bypass flow

L Length of the recirculation zone or of the detachment bubble

H41 Height of the incident-flow profile 41

x Axial spacing

α, β Angle

1. A heat exchanger of a gas turbine engine of an aircraft having a casing, wherein the casing has a step-like incident-flow profile in a region facing toward a flow of an air volume flow, and
the air volume flow is, in the region of the incident-flow profile, in relation to an outer side of the casing, diverted perpendicularly with respect to the outer side, over which flow passes, of the casing in a growing manner
in such a way that, downstream of the incident-flow profile and above an outer side of the casing, a recirculation zone with at least one separation bubble forms in the air volume flow,
and wherein, downstream of the incident-flow profile, there is provided at least one further step-like incident-flow profile
which, in relation to the outer side downstream of the step-like incident-flow profile and in relation to the outer side of the casing, rises outwardly, is impinged on by the air volume flow at least in an axial direction, and diverts the air volume flow in such a way
that, downstream of the further incident-flow profile, above a further outer side of the casing, a further recirculation zone forms in which in each case at least one separation bubble is present, and/or,
in the region of the incident-flow profile and/or in the region of the further incident-flow profile, there is provided an inlet of at least one flow duct which runs in the casing in the direction of a mouth
which is arranged at least approximately in the region of the outer side or which are arranged in each case in the region of the outer sides of the casing,
wherein the air volume flow conducted through the flow duct or the air volume flows conducted through the flow ducts emerges from the mouth or emerge from the mouths in each case at such an angle relative to the flow direction of the air volume flow that, downstream of the mouth or downstream of the mouths, in each case one recirculation zone with at least one separation bubble forms above the outer side(s) of the casing.

2. The heat exchanger according to claim 1, wherein the recirculation zones each have a defined length in the flow direction of the air volume flow, which lengths are dependent on heights of the effective areas of the incident-flow profiles, which correspond in each case to an area of the incident-flow profiles in each case projected into a plane which is perpendicular to the flow direction of the air volume flow.

3. The heat exchanger according to claim 1, wherein the air volume flow is, in the region of the incident-flow profile or in the region of the incident-flow profiles and/or in the region of the mouth or in the region of the mouths, diverted relative to the outer side of the casing in a growing or expanding manner such that, in the flow direction of the air volume flow, the recirculation zones are adjoined by in each case one reattachment region of the air volume flow.

4. The heat exchanger according to claim 3, wherein the mouth or the mouths is arranged in each case at least approximately in the region of the outer side or are arranged in each case in the region of the outer sides of the casing in which the reattachment region is present or in which the reattachment regions are present.

5. The heat exchanger according to claim 4, wherein the air volume flow is, in the region of the incident-flow profile or in the region of the incident-flow profiles and/or in the region of the mouth or in the region of the mouths, diverted relative to the outer side of the casing in a growing or expanding manner such that, in the flow direction of the air volume flow, the reattachment regions are adjoined by in each case one turbulent flow region.

6. The heat exchanger according to claim 1, wherein, on the outer side of the casing, there are provided cooling fins which extend substantially outward in relation to the outer side of the casing and which run at least approximately in the flow direction of the air volume flow and which are spaced apart from one another in a direction which is perpendicular to the flow direction of the air volume flow.

7. The heat exchanger according to claim 6, wherein the incident-flow profile or the incident-flow profiles and/or the outer side or the outer sides of the casing is or are arranged, in the flow direction, upstream of or at least regionally between the cooling fins.

8. The heat exchanger according to claim 6, wherein a height of the cooling fins proceeding from the outer side or proceeding from the outer sides of the casing is in each case constant, or increases at least regionally in the flow direction of the air volume flow, over the length of the cooling fins.

9. The heat exchanger according to claim 8, wherein the height of the fins increases linearly or parabolically.

10. The heat exchanger according to claim 1, wherein a spacing between in each case two incident-flow profiles in the flow direction of the air volume flow lies in a range between one and ten times the height of the effective area of the in each case front incident-flow profile in the flow direction of the air volume flow, preferably in a range between four and five times the height of the effective area of the front incident-flow profile.

11. The heat exchanger according to claim 6, wherein the cooling fins end, in the flow direction of the air volume flow, upstream of that region of the outer side or upstream of those regions of the outer sides of the casing in which the mouth of the flow duct is arranged or in which the mouths of the flow ducts are arranged, and/or begin downstream of the region or downstream of the regions.

12. The heat exchanger according to claim 1, wherein the step-like incident-flow profiles extend at least approximately transversely with respect to the flow direction of the air volume flow.

13. The heat exchanger according to Clam 1, wherein the step-like incident-flow profiles are formed at least regionally with a convex and/or planar face area directed counter to the flow direction of the air volume flow, which face areas enclose in each case an angle of between 0° and 90° with the outer sides of the casing.

14. The heat exchanger according to claim 1, wherein the casing of the heat exchanger, in the assembled operating state, extends in a circumferential direction of the gas turbine engine and is of curved form in the circumferential direction and, in the circumferential direction, delimits a flow region of the air volume flow.

15. The heat exchanger according to claim 14, wherein the casing of the heat exchanger is formed as a closed ring-shaped body or as a ring segment.
